(19) United States
(12) Patent Application Publication
(10) Pub. No.: US 2023/0222557 A1
(43) Pub. Date: Jul. 13, 2023

(54) METHOD AND DEVICE FOR ORDER PROCESSING FOR DENTAL PROSTHESIS PART MANUFACTURE

(71) Applicant: BEGO BREMER GOLDSCHLÄGEREI WILH. HERBST GMBH & CO. KG, Bremen (DE)

(72) Inventors: Igor PFEIFER, Stuhr (DE); Axel KLARMEYER, Verden (DE); Stefan GOTTSCHLICH, Bremen (DE)

(73) Assignee: BEGO BREMER GOLDSCHLÄGEREI WILH. HERBST GMBH & CO. KG, Bremen (DE)

(21) Appl. No.: 17/796,312

(22) PCT Filed: Jan. 27, 2021
(86) PCT No.: PCT/EP2021/051815

§ 371 Date: Mar. 6, 2023

(30) Foreign Application Priority Data
Jan. 29, 2020 (DE) 10 2020 102 166.6

(51) Int. Cl. G06Q 30/0601; G06Q 50/04; B33Y 50/00; B33Y 80/00; B29C 64/386; A61C 13/00

(52) U.S. Cl. CPC G06Q 30/0621; G06Q 50/04; B33Y 50/00; B33Y 80/00; B29C 64/386; A61C 13/0004; B29L 2031/7532

(57) ABSTRACT

The invention relates to a server for sending and receiving data, in particular for an order control of production orders, wherein the server is adapted to establish a data connection with a plurality of order computers arranged distanced from the server at an orderer location and to receive an order data package containing geometric anatomy information, in particular about a digital dental impression of a patient and address information about the order computer, from each one of these order computers.

The present invention relates to a server for sending and receiving data, in particular for order control of production orders. Furthermore, the invention relates to a production device, in particular designed as an additive manufacturing device or as a CAD/CAM production device, for production of one or more products, in particular medical products such as dental prostheses, other dental products, implants and/or medical prostheses. The server according to the invention, the method according to the invention and the production device according to the invention are basically suitable in an advantageous manner for the production of products. In particular, it is suitable for the time-critical production of medical products with the high safety and quality standard then required, with at the same time desired production that is fast in terms of time and secure in terms of the completion date. A typical example of this is the production of dental prostheses or dental products that have to be produced as individual products according to individual anatomical conditions. Often, several such products are combined in one batch and produced in one production run. When reference is made below to the example of the production of dental prostheses, this is not to be understood restrictively, but rather generally to the production of individual products. When reference is made hereinafter to an individual product, this is to be understood as meaning a single product or several products. In particular, this also means several products which are produced from a matching material and/or which are produced in a common production run on one production device.

A traditional and still widely used procedure for producing dental prostheses is for the dentist to take an impression of the patient's oral cavity using an impression material, send this impression to a dental laboratory located spatially distanced from the patient, and the dental laboratory uses this impression as the basis for producing the dental prosthesis, e.g. a crown, bridge, inlay or an onlay, in a multi-stage production process, e.g. a casting process with a lost model and lost mold. The dental prosthesis is returned from the dental laboratory to the dentist and, if necessary, reworked by the dentist before it is placed in the patient's mouth. Spatial distance is understood here and below to mean a spatial distance of at least 200 meters and typically several kilometers, i.e. a spacing beyond an arrangement of the two locations in one local economic unit. Two spatially distanced units in the sense of the invention can in particular also be understood as two economically independent units.

In the field of dentistry, it is by now also known to use computer-aided impression and design processes and computer-aided production processes based on them, such as CAD/CAM milling processes, stereolithographic processes or the selective laser melting/sintering process or other additive manufacturing processes for the production of dental prostheses and other dental products. Here, too, the starting point for the fabrication of the individual dental prosthesis and other individual dental products can be an impression from the patient's oral cavity. In addition to the aforementioned classic impression using impression material, a digital impression is also known for these processes, which leads directly to digital data. A digital impression is typically taken with an intraoral scanner, wherein an optical scanning process is used to create a digital impression of the patient without the need for an impression with an impression material. However, a digital impression can also be made by other means, for example by means of a scan of a plaster model made on the basis of an impression made with an impression material.

The data of the digital impression must then be processed by a dental expert on the basis of the anatomical conditions and the technical production conditions, for example, in order to provide geometric corrections or geometry changes necessary for therapeutic purposes. The planning can be created directly by the qualified person or there can be partially or fully automated planning in which a proposal for a geometry definition is created by planning software on the basis of imaging data of the anatomical conditions and this proposal is checked by a qualified person, modified if necessary and confirmed. This results in a geometry definition of the dental prosthesis. This geometry definition describes the geometric dimensions of the dental prosthesis. This can include the geometric dimensions of a crown, a bridge or an inlay. Furthermore, the geometry definition may also include geometric dimensions of other elements associated with the dental prosthesis, for example, an implant, an abutment. Finally, the geometry definition can also contain geometric data on an installation position of the implant and/or the dental prosthesis, and geometric data of a template or navigation device, which can be used as an aid for an implantation procedure of the implant.

Subsequently to this extraction of the geometry definition of the actual dental prosthesis, the geometry data must be converted into production data. Here, the data must be processed by a person skilled in production technology in order to determine, for example, the alignment of the prosthesis to be produced within the production device (e.g. on a base plate) and to determine the arrangement of production aids such as supports. On the one hand, this production data can be created manually in a production planning process by the person skilled in production technology, but alternatively a proposal can also be developed by an appropriately trained production planning software, which is checked, modified if necessary and confirmed by the person skilled in technology.

The invention is basically aimed at such a production of individually planned products, such as implants, dental prostheses and the like, in a rapid prototyping process. A particular problem with this individual production results from the fact that, on the one hand, the material to be used can differ from product to product and, on the other hand, the quantity of material required for a product differs from product to product. If a rapid prototyping production process is started with an existing material quantity that is smaller than the required material quantity, this leads to an incomplete and thus faulty formation of the product.

Since different material sources are often available for production, efficient production planning is therefore a problem.

Additive manufacturing equipment such as 3D printers or laser melting/sintering systems often have the capacity to produce multiple dental prostheses in one production process. Therefore, it is usually also necessary to combine several individual orders for dental prostheses for the purpose of utilizing the capacity of the production device when creating the production data. Subsequently, the actual physical production of the dental prosthesis or other dental products can take place on the basis of the production data created in this way.

This production of dental prostheses is typically in an independent dental laboratory or a special production center located at a distance from the dental practice, which has the special production equipment, some of which requires special knowledge in terms of operation.

For the production of dental prostheses and other dental products, CNC milling machines or additive production devices such as 3D printers or laser melting systems/laser sintering systems are often used, which produce the dental prosthesis on the basis of a block output blank (CNC milling machines) or a liquid or powdery starting material (additive production devices). Often, the acquisition of one or even several such highly specialized production facilities is not feasible and reasonable for a dental practice or dental laboratory, as the system cannot be utilized economically. The time advantage of rapid production with short delivery routes is not or insufficiently realized as a result.

For example, a method for production of dental components is known from DE102008060860A1, wherein a three-dimensional CAD model of a dental component is generated based on geometry data generated in an intraoral scanning process, numerous CAD model layers are generated from the CAD model by processing the geometry data as layer data, and a laser sintering process or a laser melting process is carried out in a computer-based manner based on the layer data of the CAD model layers.

A fundamental problem that arises in the creation of dental prostheses and other dental products is due to the fact that from the step of creating a digital impression in the dental practice to the insertion of the dental prosthesis in the dental practice, many steps are necessary, each of which requires an activity of one of the persons involved in the process. For example, data containing information about the digital impression must be created and, if necessary, modified with dental knowledge. The data must then be sent together with an order to a dental laboratory that is spatially distanced from the dental practice. Furthermore, the dental laboratory commissioned must, for example, provide data containing information on the geometry of the dental prosthesis and created on the basis of the digital impression with production information using production knowledge, check the producibility on the basis of a plausibility check, plan production-specific data such as the alignment of the products in the production device, or any auxiliary constructions such as supports or reference elements, and transmit the production data verified and modified in this way to a production device that is currently available and ready for use. This special production device is often located in a production center, i.e. it is spatially distanced from the dental laboratory and the dental practice.

This type of production scheduling- and control is also common for other products—in this case, a production scheduling location and a production scheduling computer are used instead of the dental laboratory location and the dental laboratory computer.

At these and further steps, delays frequently occur, delaying the entire production process. In particular, this type of order processing means that rapid and precisely timed production cannot be achieved and thus, for example, a spontaneous or short-term treatment and care of a patient cannot be achieved for the production of dental prostheses or other medical products, or that production facilities cannot be utilized to capacity because, for the purpose of rapid completion of a product such as a specific dental prosthesis, a production run with a capacity for, for example, approx. fifty products (dental prosthesis parts) must be started with only a single product or a number of products that is significantly below the capacity limit because the production data for this single product or these few products are only available. Furthermore, errors in data preparation and forwarding can occur with the known processes, resulting in a defective product.

The invention is therefore based on the task of providing a production method with which the time required for the production of one or more products, in particular medical products such as dental prostheses, other dental products, implants and/or medical prostheses, can be reduced - wherein this reduction in time required is intended to relate in particular to the actual duration of time between the time of the initial indication for the production of an individual product (i.e. the determination of need) and the time at which the finished product is available to the user.

According to a first aspect, this task is solved by a server for sending and receiving data, in particular for an order control of production orders, with the features of claim 1. The server for sending and receiving data, in particular for an order control of production orders, is thereby adapted to establish a data connection with a plurality of order computers arranged at a distance from the server at an orderer location and to receive an order data package, which contains geometric information about a digital impression of a patient and address information about the order computer, from each of these order computers, to establish a data connection with a plurality of production planning computers distanced from the server at a production planning location and sending each of the received order data packages to one of the production planning computers and receiving from each one of said production planning computers production data packages containing geometric and production flow control information for the production of one or more medical products such as dental prostheses, other dental products, implants and/or medical prostheses and address information about a production device and which have been created in dependence on order data packages, to establish a data connection with a plurality of production control computers each located at a production location distanced from the server, and to receive from each of these production control computers and/or from each production device controlled by these production control computers a device data package which contains information about production devices controlled by these production control computers, wherein the production devices are preferably 3D printers, and to receive a status data package which contains information about materials to be processed with the respective production device and/or information about the operating status of the respective production device, to send the production data packages respectively to the production control computer that controls the production device specified in the address information about a production device in the production data package.

The order computers are preferably arranged at locations spatially distanced from the server and/or in buildings different from the server. The order computers are also spatially distanced from each other, i.e. arranged at different locations, in particular in different dental practices. The production planning computers are also spatially distanced from one another and may be arranged in particular in a dental laboratory. Finally, the invention also includes addressing and data transmission to production control computers that are also spatially distanced from one another. However, this does not preclude that multiple production control computers can be present at a production location, in particular when individual production control computers are integrated into individual production devices. For example, several production devices can be located at one production location, for example in order to provide a higher production capacity or to be able to process several different materials simultaneously by means of these several production devices.

The production control computers are preferably each arranged in close proximity to or integrated in the production device, which is controlled by the production control computer.

The geometric anatomical information on the digital impression of a patient have for example been created with an intraoral scanner. The digital impression includes in particular three-dimensional geometric information about the patient's dental situation.

Preferably, the order data package can comprise address information about the orderer, wherein an assignment file exists on the server by means of which the order data package is uniquely assigned to a dental laboratory by an orderer. In this way, it can be achieved that an orderer with one or more production planning locations (for example, a dentist with one or more dental laboratories) defines, at which a production of the medical products is to take place for him. In the same way it is achieved this way that a production planning location (a dental laboratory) does not have to be assigned to a single orderer (dentist), but can efficiently process and execute orders from several different orderers.

A first advantage is that fewer manual steps in the process are required, which can cause delays in the process or errors in the process, because the server can substantially automated take over the order control of production orders to produce the medical product.

Another advantage is that the server can execute and plan the single-production orders into bundled production collective orders in an efficient way, since the server can via the data connections query current information, such as utilization, about the production planning computers (the dental laboratory computers) and about the status of the production devices or receives this information and in dependence of this information can select production planning computers and production devices for production planning and production, which have corresponding capacities for immediate or prompt processing. In this way, the spatial proximity to the dental practice for the purpose of short delivery routes, the utilization of the production facilities and the time of the start or end of production can be better taken into account and planned more optimally.

In a particularly preferred embodiment, the server is adapted to send a status data package, which is assigned to a particular production device, to a production planning computer, which has received an order data package for creating a production data package for production of the medical device. The status data package preferably has current information about materials to be processed with the particular production device and/or information about the operational status of the particular production device. An advantage of this embodiment is that information about the current status of a particular production device is known at the production planning location (dental laboratory). Thereby, the orders in the dental laboratory can be processed depending on the information about the current status of the specific production device.

According to a further preferred embodiment, it is provided that the order data package contains information about at least one material to be used and/or information about an indication. A particular advantage is that the information about the materials to be used and/or about an indication is automatically transmitted to the production planning computer and thus this information is available when the order is received in the dental laboratory.

Further it is preferred if the server is adapted to generate release data in dependence of a comparison of information contained in the status data package about a material stock volume available for the production device specified in the address information about a production device and information derivable from the production data package about a production volume required for the production of the medical product with the production data, if the material stock volume is greater than or equal to the production volume, and to send the release data, for releasing and/or starting the production of The medical product with the production devices by means of information of the production data package, to the corresponding production control computer.

Thereby, it is preferably by the comparison of the information about the material volume present in the production device intended for production and the material volume required for production possible to create release data. This is preferably done when the volume of material present is greater than or equal to the volume of material required. The release for starting the production can thus be made Dependent on whether enough material is available.

Even further, it is preferred if the production location and the orderer location are the same. Such a constellation exists, for example, if at a dentist as the orderer a production device is on site. This is particularly advantageous because, for example, a dentist as the orderer can dispose of the produced products particularly quickly.

Still further, it is preferred that the status data includes an expiration date of a material to be processed held for the production device specified in the address information about a production device, which is specified in the production data, and that the server is adapted to determine the time difference between the expiration date of the material to be processed and a planned production date for the production of the medical product, and, in dependence on the determined time difference, to release the production of the medical product to the respective production control computer if the expiration date is later than the planned production date, wherein preferably, if the server does not release the production of the medical product, information about the expiry of the expiration date of the material to be processed is sent to the respective production control computer of the production device and/or to the respective order computer.

Thereby the planned production date is preferably a production date or production end date contained in the order data package. Particularly preferably, the planned production date is a production end date calculated from a production date contained in the order data package. In particular, the planned production date is a production date determined from the device data package or the status data package, or a production end date calculated from the production data using information from the device data package.

Still further, it is preferred if the status data includes stock information about a quantity in stock of a material to be processed at the production location of the production device for the production device defined in the address information and the server is adapted to determine the difference between the stock data and a quantity of the material to be processed required for the production of the medical product, and in dependence on the difference to release the production of the medical product if the stock data results in a quantity in stock which is greater than or equal to the required quantity, wherein preferably, if the server does not release the production of the medical product, an information about the required quantity of the material to be processed is sent to the respective production control computer of the production device and/or to the respective order computer.

Thereby it is particularly advantageous that if the required quantity is not sufficient, the production is not released and thus preferably no production that cannot be completed is started. A further advantage is that in the case where the production is not released, the information about the required quantity of material to be processed is automatically sent to the production control computer and/or the order computer, whereby an immediate reaction to this information can take place.

Still further, it is preferred if the server is characterized in that the device data package or the production data package includes production principle information, which characterizes a specific additive manufacturing principle, wherein this additive manufacturing principle is preferably selected from the list: Digital Light Processing and Stereolithography with build-up of the product below the substrate plate, Digital Light Processing and Stereolithography with build-up of the product above the substrate plate, Multijet and

Fused Deposition Modeling, and Selective Laser Melting/-Sintering, the server is adapted to calculate the quantity of the material to be processed required for the production of the medical product, in that a predetermined calculation algorithm associated with the production principle information is selected on the basis of the production principle information, from the production data package, a geometric quantity of the product relevant to the production principle characterized by the production principle information for the required quantity of the material to be processed, which is preferably selected from the list: Product volume, maximum product height above a substrate plate and auxiliary construction volume is calculated, in dependence on the production principle information furthermore from the production data package an information characterizing the installation space is taken, which is preferably selected from the list: construction container cross-sectional area and substrate plate area, and/or by means of inserting the relevant geometric quantity and, if applicable, the information characterizing the installation space into the associated calculation algorithm, the required quantity of the material to be processed is calculated.

Thereby, preferably the predetermined calculation algorithm associated with the production principle information is stored on the server. Particularly preferably, several respective predetermined, calculation algorithms assigned to the production principle information are stored on the server. The calculation algorithms can in particular be stored on the server for several different additive manufacturing principles.

According to a further preferred embodiment, the server is characterized in that the device data package or the production data package contains a production principle information, which characterizes a specific additive manufacturing principle, wherein this additive manufacturing principle is preferably selected from the list: Digital Light Processing and Stereolithography with build-up of the product below the substrate plate, Digital Light Processing and Stereolithography with build-up of the product above the substrate plate, Multijet and Fused Deposition Modeling, and Selective Laser Melting, the server is adapted, to if the production principle information characterizes digital light processing or stereolithography with construction of the product below the substrate plate as the production principle, calculate the required material volume as addition of the product volume and the auxiliary construction volume, if the production principle information characterizes digital light processing or stereolithography with construction of the product above the substrate plate as the production principle, calculate the required material volume as multiplication of the maximum product height above the substrate plate and the installation container cross-sectional area, if the production principle information characterizes the multijet process or the fused deposition modeling as production principle, calculate the required material volume as addition of the product volume and the auxiliary construction volume, and/or if the production principle information characterizes the selective laser melting as production principle, calculate the required material volume as multiplication of the maximum product height above the substrate plate and the substrate plate area.

Thereby, it is particularly advantageous that, due to the consideration of the production principle, the required material volume can be determined automatically for each existing production principle.

Still further, it is preferred that the production principle information further characterizes a milling removal production process and the production data package includes a milling path thickness, and that the server is adapted to calculate, when the production principle information as production principle characterizes the milling removal production process, the required material volume as an inner volume of an envelope area lying around the product at a distance corresponding to the milling path thickness.

Thereby it is particularly advantageous that, for example, when using a CNC milling process based on CAD/CAM data, the material volume required for production can be determined automatically.

Further it is preferred that the server is adapted to calculate the quantity of a material to be processed that is in stock in a production device at a specific point in time lying in the future, in particular after a specific number of production orders, in dependence of the quantity of a material to be processed that is in stock in a production device and the quantity of a material to be processed that is required for a specific number of production orders, and, in dependence on the quantity of a material to be processed in stock at a certain point in time in the future and the quantity of the material to be processed required for a production order, to release a production of the medical product for the certain point in time in the future if the quantity in stock is greater than or equal to the quantity required, wherein preferably, if the server does not release the production of the medical product, an information is sent to the respective production control computer of the production device.

Thereby, preferably, several planned production orders are included in the calculation of a future quantity in stock of a material to be processed. Thereby it is particularly advantageous that planning of production orders lying in the future is possible and can be automated, while taking into account further production orders.

Still further, it is preferred that the server is adapted to calculate the quantity of a material to be processed that is in stock in a production device at a certain point in time lying in the future, in particular after a certain number of production orders, in dependence on the maximum height of a, in particular the highest, product, to be produced on a building platform and of a cross-section of an installation space defined in the device data of the production device.

Still further, it is preferred if the order data package contains information about a treatment date related to a particular dental prosthesis or dental product described in the production data package, on which a treatment of the patient with the particular dental prosthesis or dental product is planned, and the server is adapted to determine the time difference between the treatment date and a production date for the production of the particular dental prosthesis or dental product, and, in dependence on this determined time difference, to release the production of the medical product to the respective production control computer if the planned production date lies before the treatment date, and preferably, if the planned production date is after the treatment date, to change the planned production date so that the planned production date lies before the treatment date, in particular by changing the sequence of production orders.

Thereby, the planned production date is preferably a production start date or production end date contained in the order data package. Particularly preferably, the production date is a production end date calculated from a production start date contained in the order data package. In particular, the production date is a production start date determined from the device data package or the status data package and/or a production end date calculated from the production data using information from the device data package. The production end date thereby preferably indicates the end of production. The production start date thereby preferably indicates the start of production.

Further it is thereby preferred if the order data package contains information about a treatment date on which treatment of the patient is planned, and the server is adapted to combine a plurality of production data packages to form a production collection data package, wherein preferably a plurality of production data packages are selected and combined from the totality of production data packages stored on the server at a decision time, wherein the selection is made on the basis of the time duration between the decision time and a planned production date and those production data packages being selected whose time duration is shortest or whose time duration does not exceed a predetermined lead time, preferably 7 days, particularly preferably 3 days and in particular 2 days.

Thereby, a particular advantage of this is that several production orders can be combined for one production, whereby a plurality of medical products can be produced together. Another advantage is that the combination of the production orders can be carried out automated and thereby certain criteria can be taken into account, so that a the selection of the combined production data packages can be conducted based on prioritization and/or consideration of the time at which the dental prosthesis and/or the other dental products are required.

Still further it is preferred that the server is adapted to, in the event that the server does not release the production of the medical product, send information about this to the respective order computer. Preferably, the order computer and/or the orderer receives the information that production has not been released immediately after production has not been released.

Further, it is preferred if the server is adapted to send information about the completion of the production of the medical product to the order computer and preferably, if the medical product(s) has/have been removed from the production device automatically or manually to indicate that a removal is now possible, to send information about this to the respective order computer.

This information, which for example can be an electronic notification, can on the one hand be used to signal to a person such as an operator that the product can be removed, for example in order to remove the product manually and carry out any post-processing steps. Such post-processing steps would be for example in the case of a product cured via polymerization, the cleaning the surface of resin residues, the post-exposure and possibly the removal of the supports; in the case of products produced by laser sinter-/or melting production it would be the removal of the supports and possibly mechanical post-processing of the surface by a blasting process with particles or by a defined machining post-processing based on CAD-CAM data. On the other hand, if the removal of the product from the production area is automatic, an automatic post-processing of the removed product can also be carried out after an appropriate transfer of the product to a post-processing facility.

Preferably, the order computer and/or the orderer receives the information that the production has been completed immediately after a production has been completed. Preferably, the order computer and/or the orderer receives the information that the dental prosthesis and/or other dental products have been removed from the production device immediately after the dental prosthesis and/or other dental products have been removed from the production device.

Still further, it is preferred if a plurality of production devices are respectively controlled by each of the production control computers, and/or a plurality of production data packages, which were created in dependence on order data packages of different order computers, each contain address information about the same production device, wherein preferably production devices of the same kind, in particular 3D printers, or production devices that are not of the same kind are controlled by each production control computer.

According to a second aspect of the invention, the problem is solved by a production device, in particular designed as a 3D printer, for production of the medical product, wherein the production device comprises an interface and a control unit connected to the interface, which are adapted to be connected to a server via a communication system in order to transmit data between the production device and the server and to control a production on the production device from these data.

The production device is preferably signally connected to the control unit. For this purpose, the production device can have an internal electronic logic unit, which is adapted to communicate with the control unit and, if necessary, can also control control sequences or implement control sequences specified via the interface. The control unit is preferably signally connected to the server, in particular by means of a communication system. Preferably, data can be transmitted from the control unit to the server and/or from the server to the control unit.

The production control computers are preferably each located in close proximity to, or integrated in, the production device, which is controlled by the production control computer.

Thereby it is preferred if the production device comprises a changing unit, which is connected to the production device and which is designed to move the produced dental prosthesis and/or the produced other dental products out of a working space of the production device after completion of the production of the medical product.

Thereby it is particularly advantageous that the dental prosthesis and/or the other dental products are automatically moved out of the working space of the production device. Thereby preferably an intervention of a person in the working space of the production device is not necessary, whereby advantageously contaminations and/or damages in the area of the working space of the production device can be avoided.

Further it is preferred that the production device comprises a feeding unit, which is connected to the production device and adapted to feed at least one material to be processed to a working space of the production device, wherein the feeding unit is preferably adapted to feed materials having the same physical and/or chemical properties or materials having different physical and/or chemical properties to the working space.

Thereby it is particularly advantageous if materials used for the production can be moved automatically into the working space of the production device. Thereby, preferably an intervention of a person in the working space of the production device is not necessary, whereby advantageously contaminations and/or damages in the area of the working space of the production device can be avoided.

According to a further aspect, the task is solved by a method for controlling production orders, comprising the steps: Establishing a data connection between a server and an order computer located distanced from the server at an orderer location; Sending an order data package, which contains geometric information about a digital impression of a patient and address information about the order computer, from the order computer to the server; Establishing a data connection between the server and a production planning computer located distanced from the server at a production planning location; Sending the received order data package from the server to the production planning computer; Sending a production data package, which contains geometric and production flow controlling information for the production of dental prostheses and/or other dental products and address information about a production device and was created in dependence on the order data package, from the production planning computer to the server; Establishing a data connection between a server and a production control computer located at a production location distanced from the server; Sending a device data package, which contains information about a production device controlled by the production control computer, wherein the production device preferably is a 3D printer, and a status data package, which contains information about material to be processed with the production device and/or information about the operating status of the production device, from the production control computer and/or from the production device controlled by the production control computer to the server; Sending the production data package to the production control computer, which controls the production device that is specified in the address information about a production device in the production data package.

Thereby it is particularly preferred if the process is used to produce dental prostheses and/or other dental products with the production device.

Further it is preferred if the method comprises: Sending a status data package, which is associated with the production device, to the production planning computer, which has received an order data package for creating a production data package for producing dental prostheses and/or other dental products.

The method can in particular be carried out with the server explained above and here using the production devices explained above.

According to a further aspect, the task is solved by a server for sending and receiving data, in particular for order control of production orders, wherein the server contains a database, in which data records are stored, which comprise device information with a production device identification about a production device controlled by the production computer, and material unit information about one or more material units which can be used in the production device with a material unit identification, and an expiration date of the material unit, and/or an existing quantity of the material in the material unit; and the server is adapted to establish data connections with a plurality of data preparation computers arranged distanced from the server and to receive from a data connection with a data preparation computer order planning data for the production of one or more products, in particular medical products such as dental prostheses, other dental products, implants and/or medical prostheses, which contain a production device identification, which determines a production device that is intended for production of the one or more products, and a material identification, which determines a material that is intended for production of the product, and, if applicable, further contains a planned production date of the product and/or the required quantity of the material needed for production of the product, establish data connections with a plurality of production computers spaced from the server and receiving from a data connection with a production computer production order data, which identify an order identification via a production order to be controlled by the production computer on a production device, a production device identification via a production device controlled by the production computer for that production order, and a material unit identification via a material unit, which is assigned to the production device controlled by the production computer for the production order and which contains a material to be processed, preferably comprising a material identification number, wherein preferably the material unit, which is intended for processing in the production device, is arranged in each case in the production device; performing a comparison between the order planning data and the data record from the database assigned to the production device and/or the material unit and, in dependence on this comparison, generating an order release signal and sending it to the order planning computer and/or performing a comparison between the production order data and the data record from the database assigned to the production device and/or the material unit and, in dependence on this comparison, generating a production release signal and sending it to the production computer.

On the server data records can be stored that are designed separately for a production device and a material unit in each case. However, information about a production device and the material units for it can also be combined in a data record. The assignment of a production device to a material that can be processed on it can also be stored on the server. This can be done in a data record for the production device or in a data record for a material unit. A separate data record can also be provided as a look-up table that assigns production devices and materials or material units to each other.

The production devices are preferably located at locations different from the server and/or in buildings different from the server. The production computers are preferably spatially distanced from each other and from the server. The production computers can be integrated into the production devices or arranged at the same location separately and adjacent to the production devices, but can in principle also be arranged at a different location than the production devices. The data preparation computers are preferably also spatially distanced from the server at a different location than the server.

The data preparation computers are preferably arranged at locations and/or buildings that are different from each other. However, in particular in this aspect of the invention, a data preparation computer may also be co-located with one or more other data preparation computers, production computers and production devices.

This aspect of the invention addresses the problem of reliable allocation and processing of production orders, which arises, for example, in an interconnected network. Thereby, in particular, the problem is addressed that, for reasons of an approval to be observed for certain products, such as medical products or products for water, air or land vehicles, or for reasons of production quality requirements, it should be avoided that certain products are produced on production devices or that certain materials are processed on production devices that do not have the necessary prerequisites for this. Furthermore, in particular the problem is addressed that a product of insufficient quality could be produced as a result of faulty order planning or faulty operation of the production device. So it is in certain applications for example possible that the product may be of insufficient quality due to the use of a material that can no longer be processed to a high quality during production. Or, because there was no longer sufficient material in the production device, the product may not be fully formed.

According to this aspect, these disadvantages are avoided by having the production planning and production start monitored by the server based on certain information and at certain times and conditions production can only be performed by a release originating from the server.

The starting point here is a database on the server. In this database information about production devices and about materials and material units are stored, which can be processed in these production devices. So for example for each production device a maximum installation space dimension or materials that can be processed can be stored in the database. Furthermore, the database contains information about the available materials contained in material units. A material unit represents a self-contained stock quantity of a certain material and such a material unit is primarily assigned an available material quantity and, if applicable, also an expiration date. Thereby several material units with the same material can be available for a production device, but they can have different available material quantities and/or expiration dates.

The material unit identification is preferably a number that uniquely identifies each of the material units. At that the material units can be clearly distinguished from one another. Each material unit identification is preferably a serial number of the respective material unit. The material unit identification can be in the form of a barcode such as a QR code, DataMatrix code or also generally 2D barcode or matrix barcode and in this way be easily readable by an image capture unit or a corresponding scanner or the like. The material unit information about a material unit are preferably stored on a data carrier, in particular in the form of an RFID chip. Thereby preferably one of the data carriers is connected to a material unit in each case. Further preferably, each material unit comprises such a data carrier.

A material unit can for example be a packaging unit of a material that serves as an already opened supply quantity for refilling the production device or that is still unopened and can be inserted/filled into the production device as a whole, or a material that has already been inserted/filled and is already partially consumed.

Preferably, the server is adapted to determine material unit information from material unit sales data and to insert it into the database, in particular by receiving material unit sales data, comprising a material quantity and, if applicable, an expiration date of one or more material units from a sales data computer, and/or receiving material unit data from a production computer and determining material unit information out of it and inserting it into the database.

The server can obtain material unit information from sales data about material units that are stored by data transfer or that are entered manually by a user.

Preferably, the server is adapted to perform a calculation of an updated material unit information based on the material unit information stored in the database by determining the volume of material consumed by the production of a product in the production device with the material unit from the order planning data or the production order data, subtracting the determined consumed material volume from the existing quantity of material in the material unit, and storing the result of the subtraction as the existing quantity of material in the material unit in the database.

According to this further development, the available material quantity is continuously updated based on calculated consumption quantities of the material from the material unit.

The production device identification about the production device preferably comprises the serial number of the production device or other data uniquely identifying the production device, such as a number, a code, a barcode or the like. Thus, the production device can be uniquely identified in an advantageous manner. In addition to this production device identification, the device information also comprises property information about the production device, for example a production method (3D printing, stereolithography, laser sintering, etc.) and can also define the materials or material units that can be processed with the production device - but this could also be done by an assignment in a separate table or by corresponding assignment information in the data records for the material units.

A first advantage is that the information about the expiration date and/or about the available material quantity for each material unit is available on the server and can thereby be updated automatically. Thereby the information about the expiration date and about the material quantity can be available at any time.

Still further it is preferred that the server is adapted to read out from the order planning data received from the data preparation computer information about the production device intended for production and the product to be produced and the material to be used for production, to perform an order matching included in the matching to determine whether the material intended for production and, if applicable, whether the product to be produced is suitable for production on the production device, in particular in that the data records contained in the database contain information about those materials, which are compatible with the production device, and the order matching comprises a check whether the material to be used matches one of these materials, information about the product is compared with the material, and/or information about a geometry of the product is compared with information about a geometry of an installation space of the production device, by checking whether the product does not have a dimension which exceeds the installation space, and if a suitability of the production device for production of the product is determined in this order matching, sending the order release signal to the data preparation computer, wherein the order release signal preferably comprises an encryption code, which is adapted to encrypt a production order to be transmitted from the data preparation computer to the production computer.

This further development is based on a release of the planned production order by the server. Thereby minimum quality requirements, such as for example the planning of a correct assignment of a material to a production device, which is capable of processing that material, can be monitored. In particular, a conscious or unconscious erroneous production can be achieved by transmitting the production orders in encrypted form after receiving an encryption code, in that the encryption code also performs a production release function.

Still further, it is preferred that the device information stored in the database comprises a mode of operation of the production device and technical properties such as a size of the installation space and types of materials that can be processed with the production device, and the server is adapted to perform the matching with the mode of operation of the production device and/or technical characteristics contained in this device information from the production device identification contained in the order planning data or the production order data.

This enables direct monitoring and approval of a correct assignment of material and production device or for example of product dimensions and installation space of the production device.

Still further it is preferred that the server is adapted to determine the material volume required for the production the product in the production device with the material unit from the information about the product to be produced contained in the order planning data or the production order data, to read out the material unit identification and/or a planned production date from the production order data received from the production computer, by means of the data record stored on the server for the material unit, to read out the quantity of material still present in the material unit and/or the expiration date of the material unit, and to carry out a production matching included in the matching in order to check whether the product intended for production can be produced with the production device intended for production and, if applicable, at the planned production time, by comparing the expiration date of the material unit with the planned production date and if the expiration date is not exceeded on the production date, sending the production release signal to the production computer, and/or comparing the available quantity of the material with the required quantity of the material, and if the available quantity is equal to or greater than the required quantity of the material sending the production release signal to the production computer, wherein the production release signal preferably comprises a decryption code adapted to decrypt an encrypted production order transmitted from the data preparation computer to the production computer.

Thereby only a production release signal is sent by the server if it has been determined on the basis of the material unit identification transmitted to the server that a material unit has been or is being used for production in the production device which still has a sufficient quantity of material and/or whose expiration date at the planned production time—i.e. if applicable at the current time—has not yet expired. This can be done—if a previously encrypted production order is used for the production, particularly securely in such a way that a decryption code is sent to the production computer when the matching has shown that required conditions have been met. In this case, the production computer can only decrypt the production data after the production release in the form of the decryption code and start and control production with the decrypted production data.

Preferably, required conditions that the server for the production matching verifies from information received from the production device are that the production order has been created for this production device, and the material of the material unit present on the production device matches the material in the production order.

The advantage of this process flow is that production devices with different calibration can be used and device-specific parameters can be used during data preparation. Due to the different calibration, it is not advisable to run a production order created for a specific production device on another production device. This can be safely avoided by matching and sending the decryption code required for production after successful matching.

Preferably, further required conditions are that for the existing material unit the expiration date is not exceeded and/or the existing material quantity of the material unit is sufficient for the planned production.

So while the basic suitability of the selected material for the product and the basic suitability of the production device for processing the material are checked for the order release, the check for the production release goes further and also checks for example whether the material unit that is to be used for production also contains sufficient material and/or this has not expired. In this way it can be avoided in an advantageous and automated way that a production with material with expired expiration date takes place and/or a production is started although the available material quantity is not sufficient. The server can thereby be adapted to compare the expiration date with the current date or to compare the expiration date with a planned production date lying in the future.

Still further, it is preferred that the server is adapted to perform a calculation of an updated material unit information based on the material unit information stored in the database by determining the material volume consumed by the production of a product in the production device with the material unit from the order planning data or the production order data, subtracting the determined consumed material volume from the existing quantity of material in the material unit, and storing the result of the subtraction as the existing quantity of material in the material unit in the database.

According to this further development, the material unit information stored on the server are continuously updated based on consumption quantities, which are calculated from the consumed material volume of production orders, which are performed with the respective material unit.

Alternatively, the server may also be adapted to receive updated material unit information from the production computer after sending the release signal and to use the updated material unit information to update the data record stored in the database regarding the material unit, in particular by receiving a material consumption quantity as updated material unit information after finishing the product, or by receiving a material consumption percentage quantity as updated material unit information after the stop of a production of the product.

In principle, preferably after releasing and/or starting and/or completing and/or stopping the production with one of the production devices, the quantity of material now still available and/or the expiration date of the material can be recalculated on the server or sent from the production computer to the server. The expiration date does not usually change in this process, but may shorten for certain material units, such as after a sealed package has been broken open, and therefore may require updating. The available material quantity changes through each complete or partial production process due to the associated material consumption and is therefore preferably stored on the server updated in each case. This is preferably done by overwriting the old values with the newly transmitted values.

Still further, it is preferred that after releasing and/or starting and/or completing and/or stopping the production with one of the production devices, that data set associated with the material unit is matched, preferably by matching the existing material quantity associated with the material unit.

According to a further aspect, the task is solved by a production device, in particular designed as a 3D printer, for production of one or more products, in particular medical products such as dental prostheses, other dental products, implants and/or medical prostheses, wherein the production device comprises a production computer or is connected to a production computer for data transmission, and the production computer is connected via a communication system to a server of the type described above and is adapted to transmit data between the production device and the server, in particular to transmit to the server an order identification identifying a production order to be controlled by the production computer on a production device, a production device identification identifying a production device controlled by the production computer for this production order, and/or a material unit identification identifying a material unit which is assigned to the production device controlled by the production computer for the production order and which contains a material to be processed, preferably comprising a material identification number.

The production device can in particular be advanced in that the production computer is adapted to receive a decryption code from the server, to decrypt an encrypted production order by means of the decryption code and to control a production on the production device with the decrypted production order data, and/or after start, after end, or after stop to transmit updated material unit information to the server.

According to a further aspect, the problem is solved by a method for production control of a production device, comprising: Establishing a data connection between a server and a data preparation computer arranged distanced from the server; sending from the data preparation computer to the server order planning data, which includes a production device identification, which determines a production device intended for production of one or more products, in particular medical products such as dental prostheses, other dental products, implants and/or medical prostheses, and a material identification which determines a material intended for production of the product, and if applicable further includes a planned production date of the product and/or the required quantity of the material needed for production of the product; establishing a data link between the server and a production computer located distanced from the server; sending of production order data, which identify an order identification about a production order to be controlled by the production computer on a production device, a production device identification about a production device controlled by the production computer for that production order, and a material unit identification about a material unit, which is associated with the production device controlled by the production computer for the production order and which contains a material to be processed, preferably comprising a material identification number, wherein preferably the material units, which are intended for processing in the production device, are arranged in the production device, from the production computer to the server; comparing the order planning data with a data record associated with the production device and/or the material from a database stored on the server and, in dependence on this comparison, generating an order release signal and sending it to the order planning computer and/or comparing the production order data with a data record associated with the production device and/or the material unit from the database and, in dependence on this comparison, generating a production release signal and sending it to the production computer.

The production computer can thereby be a control computer operating distanced from the production device or a computer integrated in the production device.

Thereby data records, preferably in a database, are stored on the server, wherein the data records contain information about production devices, in particular 3D printers, and information about material units, which are intended for processing in the production devices, wherein preferably the material units, which are intended for processing in the production devices, are arranged in the production devices in each case.

The method can be advanced by updating the material unit information of a material unit stored on the server while or after a product is/was produced with the material unit.

The method can be advanced by reading out from the order planning data received from the data preparation computer information about the production device intended for production and the material to be used for production and, if applicable, the product to be produced, determining in an order matching included in the matching whether the material intended for production and, if applicable, the product intended are suitable for production on the production device, in particular by comparing information about the product with the material, the data record contained in the database relating to the production device contains information about those materials which are compatible with the production device, and in the order matching it is checked whether the material to be used matches one of these materials, and/or information on a geometry of the product is compared with information on a geometry of an installation space of the production device by checking whether the product does not have a dimension which exceeds the installation space, and the order release signal is sent to the data preparation computer if a suitability of the production device for the production has been determined in this order matching, a production order is transmitted from the data preparation computer to the production computer, preferably in a direct data transmission bypassing the server, wherein the order release signal preferably comprises a decryption code and the production order transmitted from the data preparation computer to the production computer is encrypted with the encryption code.

The method can be further advanced by transmitting a production order from the data preparation computer to the production computer, preferably in a direct data transmission bypassing the server, from the information contained in the order planning data or the production order data about the product to be produced the material volume required for production of the product in the production device with the material unit is determined, the material unit identification and/or a planned production date is read out from the production order data received from the production computer, the quantity of the material still present in the material unit and/or the expiration date of the material unit is read out on the basis of the data record stored on the server for the production device, and in a production matching included in the matching it is checked whether the product intended for production can be produced at the planned production time with the production device intended for production, by comparing the expiration date of the material unit with the planned production date, and if the expiration date is not exceeded on the production date, sending the production release signal to the production computer, and/or comparing the available quantity of the material with the required quantity of the material, and if the available quantity is equal to or greater than the required quantity of the material, sending the production release signal to the production computer, if in this production matching a suitability of the production device and/or the material unit for the production of the product is determined, wherein the production release signal preferably comprises a decryption code and the production order transmitted from the data preparation computer to the production computer is encrypted and decrypted with the decryption code on the production computer.

The method can in particular be carried out with the server explained above, using the production devices explained above.

According to a further aspect, the task is solved by a computer program product that is adapted, when run on a computer, to execute method steps according to one of the methods explained above, in particular, if it runs on a server, to execute the method steps executed by the server, or if it runs on a data preparation computer, to execute the method steps executed by the data preparation computer, or if it runs on a production computer, to execute the method steps executed by the production computer.

Preferred embodiments are explained by way of example with reference to the accompanying figures. It show:

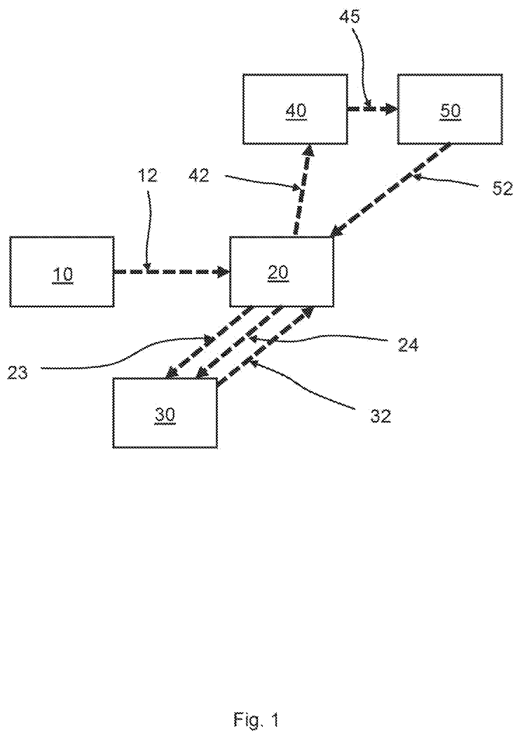

FIG. 1. a schematic representation of a first embodiment of a server for sending and receiving data for order control of production orders;

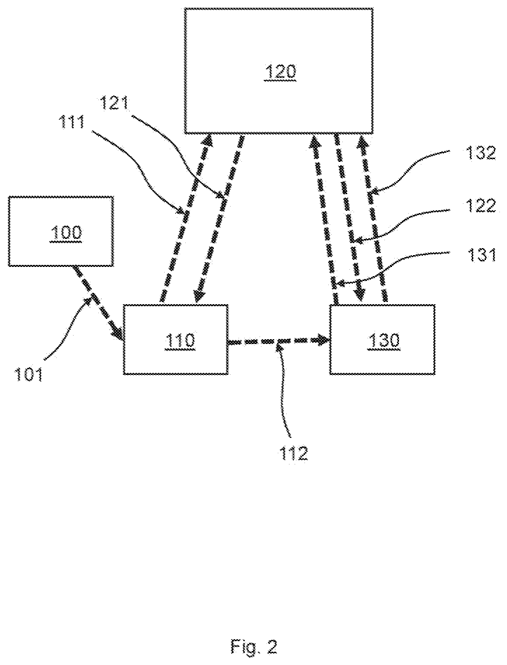

FIG. 2: a schematic diagram of a second embodiment of a server for sending and receiving data for order control of production orders.

FIG. 1 shows a server 20 for sending and receiving data for order control of production orders. In a first step, an orderer creates a digital impression of a patient using an intraoral scanner. An order computer 10 of the orderer is located at an orderer location. The order computer 10 is connected to the server 20 via a data connection 12. The order computer 10 sends order data packages via the data connection 12, each package containing geometric information about the patient's digital impression and address information about the order computer. Further, the data may include information about material selection and about patient indication. The server 20 receives this data from the order computer 10.

A dental laboratory with a dental laboratory computer 30 is located at a dental laboratory location different from the orderer location. Between the dental laboratory computer 30 and the server 20 also a data connection 23 exists. The server 20 sends the order data packages received from the order computer 10 to the dental laboratory computer 30. Subsequently, depending on the order data, a virtual design of the dental prosthesis and/or other dental products takes place in the dental laboratory. These data are processed within the dental laboratory. Thereby, a production data package is created, wherein the production data package contains geometric information and information controlling the production sequence for the production of dental prostheses and/or other dental products and address information about a production device on which the production is to take place. The production data package is then sent from the dental laboratory computer 30 to the server 20 via a data connection 32. The server 20 continuously or at the time of creation of the production data package sends information about the status of the production device to be used for the production. These information include for example an indication of whether the production device is ready for use and, if not, when it will be ready for use again. Also included in the information is the status of the materials to be used for production, in particular the quantity of material present in the material to be used and the shelf life of the material to be used.

At a production location a production control computer 40 is located. This production control computer 40 is connected to the server 20 via a data connection 42a, b. The server 20 sends the production data package received from the dental laboratory computer 30 to the production control computer 40. In this example, the production location is located in a dental practice. Also at the production location is a production device 50 that can exchange data with the production control computer 40 via a data connection 45a,b. The production control computer 40 sends an information for starting the production to the production device 50. The production device 50 continuously sends production device status information to the production control computer via a data connection 45b, which in turn can transmit this status data to the server 20 via a data connection 42b so that the server has information about the current status of the production device. This allows the server 20 to send the status information of the production device 50 to the dental laboratory computer 30. The data connection 42a, b and 45a, b may be integrally designed as bidirectional data line.

In principle, the production control computer can be integrated into the production device so that the data connection 45a,b external to the production device is omitted and the production device including the production control computer integrated therein is connected directly to the server.

FIG. 2 shows a server 120 for sending and receiving data for order control of production orders. Here, a database is present on the server 120, wherein information about production devices and information about material units intended for processing in the production devices are stored. An orderer 100 first generates scan data reflecting the actual situation at the patient. The scan data may be generated using an intraoral scanner or by scanning an impression or a model. Based on this scan data, the dental prosthesis or other dental product is created digitally, for example with a CAD program, and data records are generated from it. These data records are sent via a data connection 101 from the orderer 100 to a data preparation computer 110. The data preparation computer determines the production device with which the production is to take place and determines the material volume required. The data preparation computer 110 sends, via a data connection 111 to the server 120, order data that include information about the production device that is to be used for the production, about the material that is to be used for production, about the material volume that is required for production, and about a production number that is determined for that production.

The server checks the information received from the data preparation computer 110. In particular, the server checks whether the specified production device is entered in the database and whether the specified material may be used on this production device. This is done by matching the received order data with the data stored in the database. If the check of the server is positive, the server sends an encryption code to the data preparation computer via a data connection 121 as order release signal.

A production order encrypted with the encryption code is then sent from the data preparation computer 110 to a production computer 130 via a data connection 112, but may also for example be transmitted manually by means of a data carrier between the data preparation computer and the production computer. The production computer 130 is directly connected to the production device or integrated therein. The production order is processed on the production computer 130. The production computer 130 sends the following information to the server 120 via a data connection 131: An identification number (in form of a serial number) of the production device, a production number and a material code from an RFID chip as material unit identification. For the material code, information about the material, such as material name, batch, expiration date, existing material quantity, is stored in the database on the server. With this material code a check by the server is conducted whether the production can be started. If this is the case, i.e. the expiration date has not yet passed and there is enough material in the production device, a password is sent by the server 120 as a decryption code to the production computer 130 via a data connection 122. With this password the encrypted production order can then be decrypted. The transmission of the password thus represents the production release signal. Then the production order or production can then be executed. The entry in the database on the server for the material quantity present in this material unit is adjusted in the database according to the material quantity used in this production. By this step in the database and thus on the server always the current material quantity is saved.

If the production is stopped, the production computer 130 sends information about the stop of the production to the server 120 via a data connection 132 between the server 120 and the production computer 130. Thereby the identification number (in form of a serial number) of the production device, the production number, the material code and the quantity of material used are sent from the production computer 130 to the server 120. In the database located on the server the values, in particular the value of the quantity of material still available, can then be updated.

We claim:

1. A server for sending and receiving data, in particular for an order control of production orders, wherein the server is adapted
To establish a data connection with a plurality of order computers arranged at a distance from the server at an orderer location and to receive an order data package, which contains geometric anatomy information, in particular about a digital dental impression of a patient and address information about the order computer, from each of these order computers,
To establish a data connection with a plurality of production planning computers distanced from the server at a production planning location and to send each of the received order data packages to one of the production planning computers and to receive from each one of those production planning computers production data packages that are
geometric and production flow control information for the production of one or more medical products such as dental prostheses, other dental products, implants and/or medical prostheses and address information about a production device and have been created in dependence on order data packages,
To establish a data connection with a plurality of production control computers, each located at a production location distanced from the server, and to receive from each of these production control computers and/or from each production device controlled by these production control computers
a device data package which contains information about production devices controlled by these production control computers, wherein the production devices are preferably 3D printers,
and to receive a status data package which contains information about materials to be processed with the respective production device and/or information about the operating status of the respective production device,
To send the production data packages respectively to the production control computer that controls the production device specified in the address information about a production device in the production data package.

2. The server according to claim 1, wherein the server is adapted to send a status data package, which is associated with a particular production device, to a production planning computer, which has received an order data package for creating a production data package for production of the medical device, wherein, preferably, the order data package contains information about at least one material to be used and/or information about an indication.

3. (canceled)

4. The server according to claim 1, wherein the server is adapted to
in dependence on a comparison of information contained in the status data package about a material stock volume available for the production device specified in the address information about a production device and information derivable from the production data package about a production volume required for production of the medical device with the production data, generate release data if the material stock volume is greater than or equal to the production volume, and
to send the release data, for releasing and/or starting the production of the product with the production devices by means of information of the production data package, to the corresponding production control computer.

5. (canceled)

6. The server according to claim 1, wherein, the status data include an expiration date of a material, which is specified in the production data, to be processed held for the production device specified in the address information about a production device, and in that the server is arranged to
Determine the time difference between the expiration date of the material to be processed and a planned production date for the production of the medical device,
and, in dependence on the determined time difference, to release the production of the medical product to the respective production control computer if the expiration date is later than the planned production date,
wherein preferably, if the server does not release the production of the medical product, an information about the expiration of the expiration date of the material to be processed is sent to the respective production control computer of the production device and/or to the respective order computer.

7. The server according to claim 1, wherein, the status data includes stock information about a quantity in stock of a material to be processed at the production location of the production device for the production device defined in the address information, and the server is adapted to
determine the difference between the stock data and a quantity of the material to be processed required for the production of the medical product,
and in dependence on the difference to release the production of the medical product if the stock data results in a quantity in stock that is greater than or equal to the required quantity,
wherein preferably, if the server does not release the production of the medical product, an information about the required quantity of the material to be processed is sent to the respective production control computer of the production device and/or to the respective order computer.

8. The server according to claim 7, wherein
the device data package or the production data package includes a production principle information, which characterizes a specific additive manufacturing principle, wherein this additive manufacturing principle is preferably selected from the list: Digital Light Processing and Stereolithography with build-up of the product below the substrate plate, Digital Light Processing and Stereolithography with build-up of the product above the substrate plate, Multijet and Fused Deposition Modeling, and Selective Laser Melting,
the server is adapted to calculate the quantity of the material to be processed required for the production of the medical product, in that
a predetermined calculation algorithm associated with the production principle information is selected on the basis of the production principle information,
from the production data package, a geometric quantity of the product relevant to the production principle characterized by the production principle information for the required quantity of the material to be processed, which is preferably selected from the list: Product volume, maximum product height above a substrate plate and auxiliary construction volume is calculated,
in dependence on the production principle information furthermore from the production data package an information characterizing the installation space is taken which is preferably selected from the list: installation container cross-sectional area and substrate plate area,
to calculate the required quantity of material to be processed by means of inserting the relevant geometric quantity and, if applicable, the information characterizing the installation space into the associated calculation algorithm.

9. (canceled)

10. (canceled)

11. The Server according to claim 1, wherein the server is adapted to
calculate the quantity of a material to be processed that is in stock in a production device at a certain point in time lying in the future, in particular after a specific number of production orders, in dependence on the quantity of a material to be processed that is in stock in a production device and the quantity of a material to be processed that is required for a specific number of production orders,
and, in dependence on the quantity of a material to be processed in stock at a certain point in time in the future and the quantity of the material to be processed required for a production order, release a production of the medical product for the certain point in time lying in the future, if the quantity in stock is greater than or equal to the quantity required,
wherein preferably, if the server does not release the production of the medical product, an information is sent to the respective production control computer of the production device.

12. The server according to claim 11, wherein the server is adapted to
calculate the quantity of a material to be processed that is in stock in a production device at a certain point in time lying in the future, in particular after a certain number of production orders, in dependence on the maximum height of a, in particular the highest, medical product to be produced on a building platform and of a cross-section of an installation space defined in the device data of the production device.

13. The server according to claim 1, wherein
the order data package contains information about a treatment date related to a specific medical product described in the production data package, on which a treatment of the patient with the medical product is planned,
and the server is adapted to
determine the time difference between the treatment date and a production date for the production of the medical product,
and, in dependence on this specific time difference, release the production of the medical product to the respective production control computer if the planned production date lies before the treatment date,
and preferably, if the planned production date is after the treatment date, to change the planned production date so that the planned production date lies before the treatment date, in particular by changing the sequence of production orders.

14. The server according to claim 1, wherein
the order data package contains information about a treatment date on which a treatment of the patient is planned,
and the server is adapted to combine a plurality of production data packages to form a production collection data package,
wherein preferably a plurality of production data packages are selected and combined from the totality of production data packages stored on the server at a decision time, wherein the selection is made on the basis of the time duration between the decision time and a planned production date and those production data packages being selected,
whose duration is the shortest or
whose time duration does not exceed a predetermined lead time, preferably 7 days, particularly preferably 3 days and in particular 2 days.

15. (canceled)

16. (canceled)

17. (canceled)

18. A production device, in particular designed as a 3D printer, for production of one or more medical products such as dental prostheses, other dental products, wherein
the production device comprises an interface and a control unit connected to the interface, which are adapted to be connected to a server according to any one of the preceding claims via a communication system, in order to transmit data between the production device and the server and to control a production on the production device from these data, wherein preferably a changing unit, which is connected to the production device and is adapted to move the medical product out of a working space of the production device after completion of the production.

19. (canceled)

20. The production device according to claim 18, comprising
a feeding unit connected to the production device and adapted to feed at least one material to be processed to a working space of the production device,
wherein the feeding unit is preferably adapted to feed materials with the same physical and/or chemical properties or materials with different physical and/or chemical properties to the working space.

21. A method for controlling production orders, comprising the steps:
a) Establishing a data connection between a server and an order computer located distanced from the server at an orderer location;
b) Sending an order data package, which contains geometric anatomical information of a patient, in particular about a digital dental impression of the patient and address information about the order computer, from the order computer to the server;
c) Establishing a data connection between the server and a production planning computer located distanced from the server at a production planning location;
d) Sending the received order data package from the server to the production planning computer;
e) Sending a production data package, which contains geometric and production flow controlling information for the production of one or more medical products such as dental prostheses, other dental products, implants and/or medical prostheses and address information about a production device and was created in dependence on the order data package, from the production planning computer to the server;
f) Establishing a data connection between a server and a production control computer located at a production location distanced from the server;
g) Sending
a device data package, which contains information about a production device controlled by the production control computer, wherein the production device is preferably a 3D printer,
and a status data package, which contains information about material to be processed with the production device and/or information about the operating status of the production device, from the production control computer and/or from the production device controlled by the production control computer to the server;
h) Sending the production data package to the production control computer, which controls the production device that is specified in the address information about a production device in the production data package.

22. The method according to claim 21, comprising:
i) Production of the medical product with the production device, and
j) sending a status data package, which is associated with the production device, to the production planning computer, which has received an order data package for creating of a production data package for production of the medical device.

23. (canceled)

24. (canceled)

25. A computer program comprising non-transitory instructions that when run on a computer, carry out method steps according to claim 21, in particular,
a. if the computer program runs on a server, to execute the method steps executed by the server, or
b. if the computer program runs on an order computer, to execute the method steps executed by the order computer, or
c. if the computer program runs on a production planning computer, to execute the method steps executed by the production planning computer, or
d. if the computer program runs on a production planning computer, to execute the method steps executed by the production planning computer.

26. A server for sending and receiving data, in particular for an order control of production orders,
wherein the server contains a database in which data records are stored, which comprise
A device information with a production device identification about a production device controlled by the production computer; and
Material unit information about one or more material units which can be used in the production device with
A material unit identification, and
an expiration date of the material unit, and/or
an existing quantity of the material in the material unit;
and the server is adapted to
establish data connections with a plurality of data preparation computers arranged distanced from the server and to receive from a data connection with a data preparation computer order planning data for the production of one or more products, in particular medical products such as dental prostheses, other dental products, implants and/or medical prostheses, which contain
a production device identification, which identifies a production device that is intended for production of the one or more products; and
a material identification, which determines a material that is intended for production of the product, and, if applicable, furthermore
a planned production date of the product and/or the required quantity of the material needed for production of the product,
establish data connections with a plurality of production computers located distanced from the server and receive production order data from a data connection with a production computer that contain
Identify an order identification via a production order to be controlled by the production computer on a production device,
A production device identification via a production device controlled by the production computer for this production order, and
A material unit identification via a material unit, which is assigned to the production device controlled by the production computer for the production order and which contains a material to be processed, preferably comprising a material identification number,
wherein preferably the material unit, which is intended for processing in the production device, is arranged in each case in the production device;
performing a comparison
between the order planning data and the data record from the database assigned to the production device and/or the material unit and, in dependence on this comparison, generating an order release signal and send it to the order planning computer and/or
between the production order data and the data record from the database assigned to the production device and/or the material unit and, in dependence on this comparison, generating a production release signal and sending it to the production computer.

27. (canceled)

28. (canceled)

29. (canceled)

30. (canceled)

31. (canceled)

32. (canceled)

33. A production device, in particular designed as a 3D printer, for production of one or more products, in particular medical products such as dental prostheses, other dental products, implants and/or medical prostheses, wherein the production device comprises a production computer or is connected to a production computer for data transmission, and the production computer is connected to a server according to claim 26 via a communication system and is adapted to transmit data between the production device and the server, in particular to transmit to the server
An order identification that identifies a production order to be controlled by the production computer on a production device,
A production device identification that identifies a production device controlled by the production computer for this production order, and/or
A material unit identification, which is a material which is assigned to the production device controlled by the production computer for the production order and which contains a material to be processed, preferably comprising a material identification number.

34. The production device according to claim 33, wherein the production computer is adapted to
receive a decryption code from the server, decrypt an encrypted production order using the decryption code, and control a production on the production device using the decrypted data of the production order, and/or
transmit updated material unit information to the server after start, after end or after stop.

35. The method for production control of a production device, comprising:
a) Establishing a data connection between a server and a data preparation computer located distanced from the server;
b) Sending of order planning data that contain
a production device identification, which determines a production device intended for production of one or more products, in particular medical products such as dental prostheses, other dental products, implants and/or medical prostheses, and
a material identification, which determines a material intended for production of the product, and, if applicable, furthermore
a planned production date of the product and the required quantity of the material that is needed for the production of the product,
from the data preparation computer to the server;
c) Establishing a data connection between the server and a production computer located distanced from the server;
d) Sending of production order data that contain
An order identification via a production order to be controlled by the production computer on a production device identify,
A production device identification via a production device controlled by the production computer for this production order, as well as
A material unit identification via a material unit, which is assigned to the production device controlled by the production computer for the production order and which contains a material to be processed, preferably comprising a material identification number,
wherein preferably the material units, which are intended for processing in the production device,
from the production computer to the server;
Comparing the order planning data with a data record assigned to the production device and/or the material from a database stored on the server and, in dependence on this comparison, generating an order release signal and sending it to the order planning computer and/or
Comparing the production order data with a data record assigned to the production device and/or the material unit from the database and in dependence on this comparison, generating a production release signal and sending it to the production computer.

36. (canceled)

37. (canceled)

38. (canceled)

39. (canceled)

40. A computer program product comprising non-transitory instructions that, when run on a computer, perform method steps according to claim 35, in particular,
a. if the computer program runs on a server, to execute the method steps executed by the server, or
b. if the computer program runs on a data preparation computer, to execute the method steps executed by the data preparation computer, or
c. if the computer program runs on a production computer, to execute the method steps executed by the production computer.
